(19) United States
(12) Patent Application Publication
(10) Pub. No.: US 2004/0140974 A1
(43) Pub. Date: Jul. 22, 2004

(54) Vacuum fluorescent display driver

(75) Inventors: Seong Tae Hong, Seoul (KR); Taeg Il Cho, Seoul (KR)

Correspondence Address: JONATHAN Y. KANG, ESQ., LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/752,949

(22) Filed: Jan. 2, 2004

(30) Foreign Application Priority Data
Jan. 20, 2003 (KR) 3730/2003

(51) Int. Cl. G09G 5/00

(52) U.S. Cl. 345/214

(57) ABSTRACT

A vacuum fluorescent display (VFD) driver is disclosed to meet users' satisfaction and convenience by preventing a malfunction due to a noise. The VFD includes a unit for generating a parity bit.

### BACKGROUND OF THE INVENTION

1. Field of the Invention

The present invention relates to a digital TV and, more particularly, to a vacuum fluorescent display driver of a digital TV.

2. Description of the Prior Art

In general, a digital TV receiver includes a vacuum fluorescent display (VFD) as a display device displaying an operation state.

The VFD refers to a reliable high-luminance flat display and is a three-pole tube encapsulating a cathode, a grid and an anode formed in a high vacuum container. That is, in the VFD, thermal electrons discharged from the cathode are accelerated by a constant voltage applied to the grid and the anode to excite phosphor coated at the anode to emit light, thereby displaying a character, a symbol, a figure, or the like.

The VFD is commonly used as a display unit for displaying an operation state of home appliances such as a set-top box, a microwave oven, a VCR (Video Cassette Recorder) or an air-conditioner, or an electronic scale, an automobile dashboard, and the like.

The VFD device installed at a front panel of the digital TV receiver displays broadcast channel information, display format information or state information of the digital TV receiver received from the digital TV receiver.

There is provided a local key at a front panel of the digital TV to perform a power ON/OFF function, a channel up/down function, a volume up/down function without using a remote controller. According to selection of the local key, the state information of the digital TV is displayed on the VFD.

In order to drive the VFD, a VFD controller is commonly used. The VFD controller has a function of reading the local key in addition to a function of controlling the VFD. For example, if the VFD controller controls only the VFD, a GPIO (General Purpose Input Output) port controlled by a CPU (Central Process Unit) is to be used to read the local key signal, and in this case, in order to control the GPIO port, the GPIO port needs to be connected to a front panel from a main PCB of the CPU, causing a problem that a layout of the main PCB is complicated.

In addition, another problem is that a connector having many pins is needed to connect the GPIO port from the main board to the front board.

Thus, in order to solve such problems, the VFD controller used in the digital broadcast receiving set-top box has the functions of receiving the local key signal as well as controlling the VFD.

FIG. 1 is a schematic block diagram showing a construction of a CPU 100 in a main board of a digital broadcast receiving set-up box and a VFD driver in accordance with a conventional art.

As shown in FIG. 1, the conventional VFD driver 200 includes: a VFD controller 201 for transmitting a local key signal to the CPU 100 when a power switch is turned on, and receiving display data corresponding to the local key signal from the CPU 100; a VFD 202 for displaying the display data; a local key input unit 203 for generating the local key signal; and an IR (Infrared Receiver) 204 for receiving an input signal of a remote controller.

The operation of the VFD driver will now be described with reference to FIG. 2.

FIG. 2 is a timing diagram showing a process that data outputted from the CPU is inputted to the VFD controller of the VFD driver.

First, the CPU 100 uses three control signals of a strobe (STB), a clock (CLK) and a Data In (DIN), to control the VFD controller 201 of the VFD driver 200 of the front panel of the set-top box of the digital TV. After the CPU 100 applies the strobe (STB) signal in an active state (e.g., a low state), it outputs a suitable data value to the Data In (D_{IN}) line at a rising edge of the clock CLK, to thereby transmit a command to the VFD controller 201.

Thereafter, the CPU 100 transmits data to be displayed on the VFD 202 to the VFD controller 201.

The VFD controller 201 displays the display data outputted from the CPU 100 on the VFD 202. At this time, the key input signal outputted through the remote controller is transmitted to the CPU 100 through the IR 204, and the local key input signal is transmitted to the CPU 100 through the local key input unit 203 and the VFD controller 201.

The local key signal is outputted by ON/OFF operation of switching units of the local key input unit 203 in response to a user's request, and the local key input signal is transmitted to the CPU 100 through the local key input unit 203 and the VFD controller 201. The local key signal is outputted by an ON/OFF operation of switching units of the local key input unit 203 according to a user's request, and the local key signal is inputted to the VFD controller 201.

The construction of the VFD driver will now be described in detail with reference to FIG. 3.

FIG. 3 is a block diagram of the VFD driver in accordance with the conventional art, especially showing the local key input unit 203 of the VFD driver in detail.

As shown in FIG. 3, the local key input unit 203 includes 11 switching units (SW1˜SW11). If a user depresses an arbitrary key of the front panel, only switching units corresponding to the key input re turned on. In addition, 11 bits according to ON/OFF of the 11 switching units are inputted to the VFD controller 201. For example, assuming that only the switching unit SW3 is turned on while the switching units SW1, SW2 and SW4˜SW11 are turned off if the user depresses a channel-up key, a signal ‘00100000000’ is inputted as the local key signal to the VFD controller 201.

Thereafter, the VFD controller 201 transmits the local key signal to the CPU 100, and the CPU 100 outputs display data corresponding to the local key signal to the VFD controller 201.

The VFD controller 201 displays the display data on the VFD 202. For is example, channel-up state information, a changed channel number, or the like is displayed on the VFD 202.

Meanwhile, the CPU 100 also outputs display data according to an input signal of the remote controller inputted through the IR 204 to the VFD controller 201. At this time, in order for the CPU 100 to receives the local key input signal from the VFD controller 201, four control signals, that is, strobe (STB), clock (CLK), Data In (D_{IN}) and Data Out (D_{OUT}) signals as shown in FIG. 4 are required.

FIG. 4 is a timing diagram showing a process that the logical key signal outputted from the VFD controller is inputted to the CPU.

For example, the CPU applies the strobe (STB) signal in an active state, outputs a suitable data value at a rising edge of the clock (CLK) to the Data in (D_{IN}) line to transfer a key read command to the VFD controller 201, and recognize a local key signal inputted from the Data Out (D_{OUT}) at a falling edge of the clock CLK.

However, the conventional VFD driver has a problem that if there is a noise in the control lines (Strobe, Clock, Data In and Data Out), the VFD controller is not normally operated.

For example, when a key read command is performed while polling at every 90 ms to receive the local key signal, the key read command signal is recognized as a different key read command or a different key value due to influence of a noise, causes a malfunction of the VFD controller. Then, the display data outputted from the CPU is not displayed on the VFD or only a portion of the display data is displayed on the VFD.

Meanwhile, other conventional vacuum fluorescent display devices are disclosed in U.S. Pat. No. 6,005,538 issued on Dec. 21, 1999, a U.S. Pat. No. 6,535,184 issued on Mar. 18, 2003, and a U.S. Pat. No. 6,624,566 issued on Sep. 23, 2003.

### SUMMARY OF THE INVENTION

Therefore, an object of the present invention is to provide a vacuum fluorescent display (VFD) driver that can meet users' satisfaction and convenience by preventing a malfunction due to a noise.

To achieve these and other advantages and in accordance with the purpose of the present invention, as embodied and broadly described herein, there is provided a VFD driver including a means for generating a parity bit.

To achieve the above object, there is also provided a VFD driver installed in a digital TV and having a VFD controller, a VFD, a local key input unit and an IR (Infrared Receiver); including: a means installed in the local key input unit and generating a parity bit to check a parity.

To achieve the above object, there is also provided a VFD driver including: a local key input unit for generating a local key signal according to a user's demand; a parity bit generator for generating a parity bit to determine whether there is an error in the local key signal outputted from the local key input unit; a VFD controller for transmitting the local key signal and the parity bit to a CPU (Central Processing Unit) installed in a set-top box of a digital TV, and receiving display data corresponding to the local key signal from the CPU; and a VFD for displaying the display data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic block diagram showing a construction of a CPU and a VFD driver in a main board of a set-top box for receiving a digital broadcast in accordance with a conventional art;

FIG. 2 is a timing diagram showing a process that data outputted from the CPU is inputted to a VFC controller of the VFD driver;

FIG. 3 is a block diagram showing a construction of the VFD driver in accordance with the conventional art;

FIG. 4 is a timing diagram showing a process that a local key signal outputted from the VFD controller is inputted to the CPU;

FIG. 5 is a schematic block diagram showing a construction of a VFD driver in accordance with the present invention; and

FIG. 6 is a detailed block diagram showing the VFD driver in accordance with the present invention.

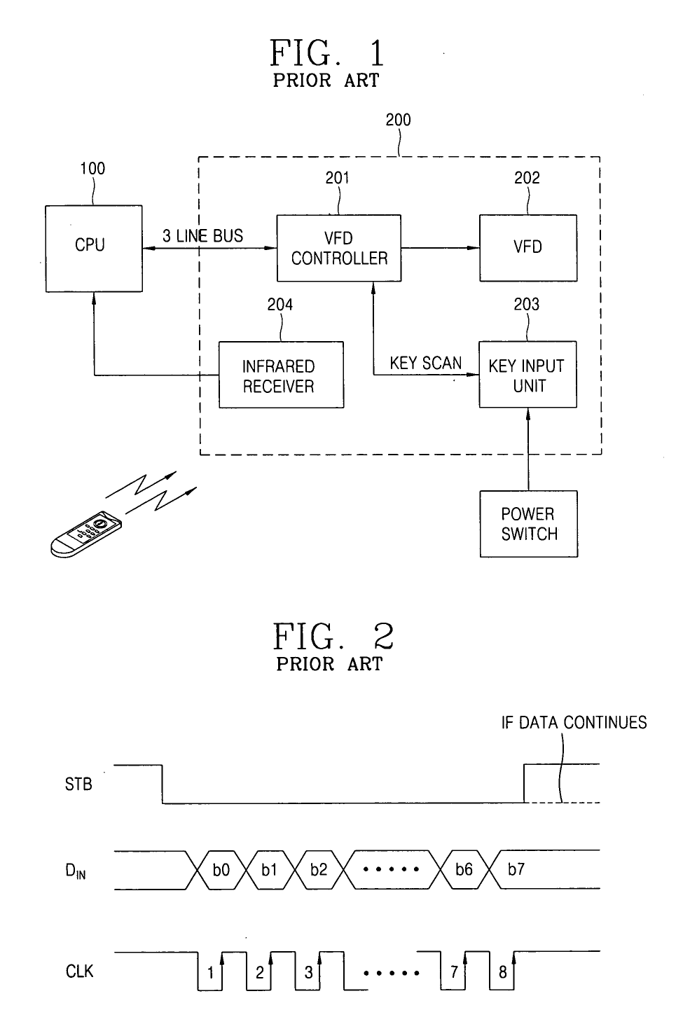

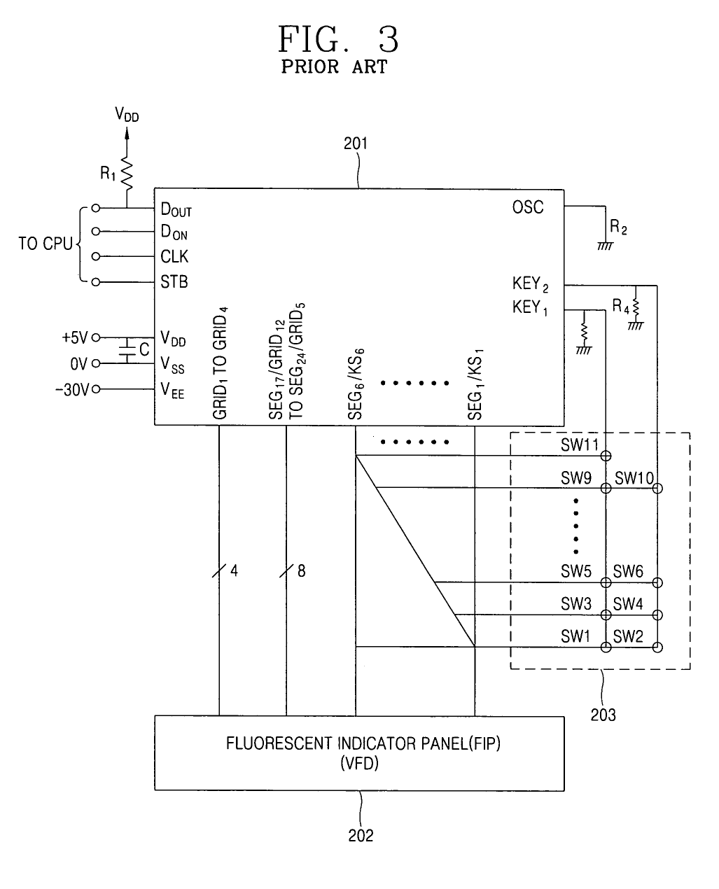

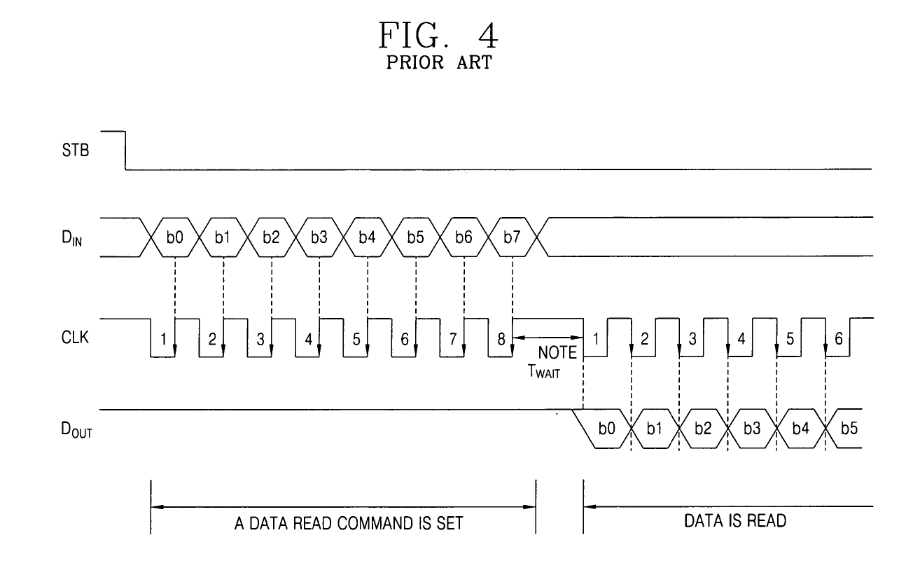

### DETAILED DESCRIPTION OF THE PREFERRED EMBODIMENTS

Reference will now be made in detail to the preferred embodiments of the present invention, examples of which are illustrated in the accompanying drawings.

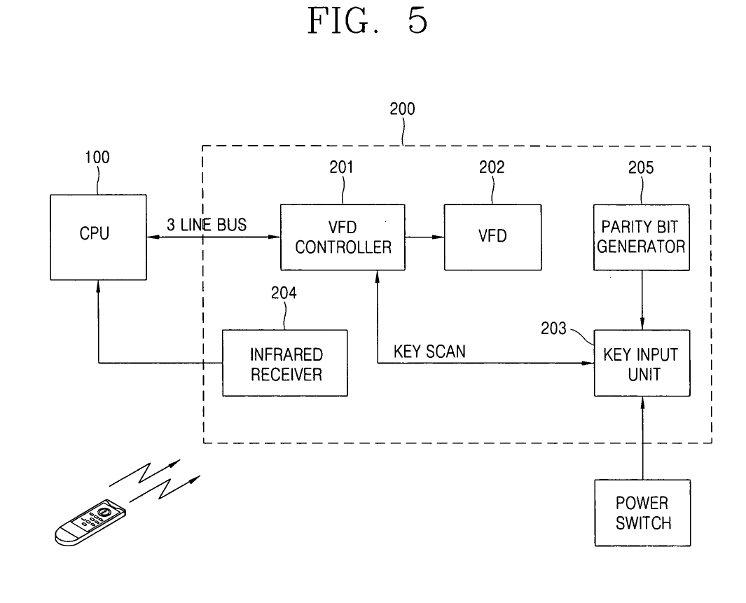

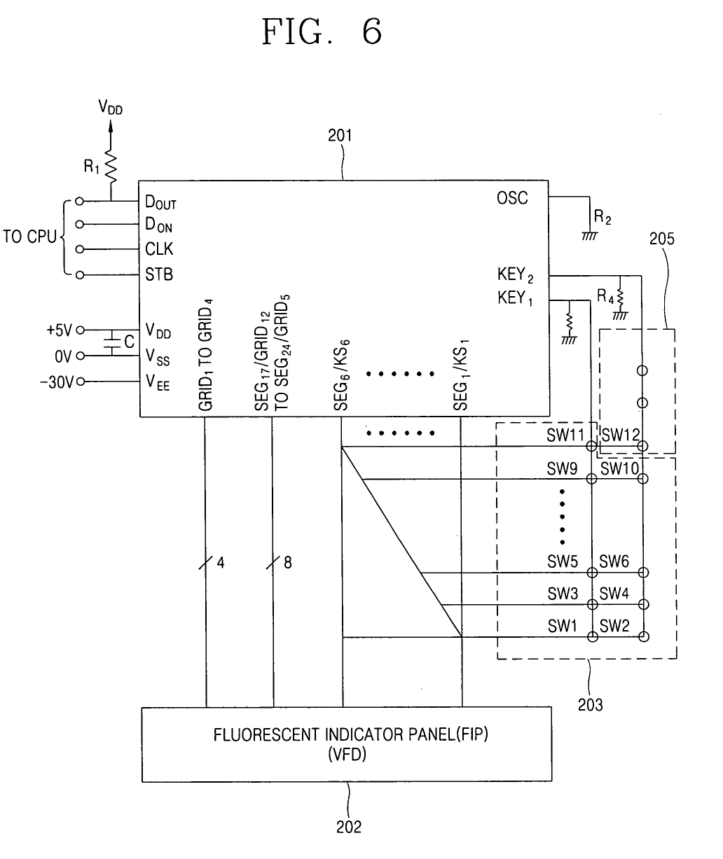

A VFD (vacuum fluorescent display) driver which is capable of preventing a malfunction due to a noise and thus offering users' satisfaction and convenience by employing a parity bit generator in accordance with a preferred embodiment of the present invention will now be described with reference to FIGS. 5 and 6.

FIG. 5 is a schematic block diagram showing a construction of a VFD driver in accordance with the present invention.

As shown in FIG. 5, a VFD driver of the present invention includes: a local key input unit 203 for generating a local key signal in response to a user's request when a power switch is turned on; a parity bit generator 205 for generating a parity bit to determine whether there is an error in the local key signal outputted from the local key input unit; a VFD controller 201 for transmitting the local key signal and the parity bit to the CPU 100 and receiving display data corresponding to the local key signal from the CPU 100; a VFD 202 for displaying the display data; and an IR (Infrared Receiver) 204 for receiving an input signal of a remote controller.

Herein, in order to reduce a fabrication cost, a switching unit SW12 is preferably used as the parity bit generator 205.

The CPU 100 determines whether there is an error in the local key signal on the basis of the parity bit.

The operation of the parity bit generator 205 applied to the VFD driver will now be described with reference to FIG. 6.

FIG. 6 is a detailed block diagram showing the VFD driver in accordance with the present invention.

First, a switch SW12 generating a parity bit is installed in the local key input unit 203. Preferably, the switch SW12 is designed to be constantly in an ON state to check a parity. Namely, the switch SW12 is designed to be forcibly depressed constantly so that the parity bit has a value ‘1’. Herein, one switch SW12 is used to generate the parity bit, but more switches for parity bit can be installed according to designers.

When the VFD controller 201 reads a local key signal of the key input unit 203, it reads 14 bits and transmits the read 14 bits to the CPU 100. Of 14 bits, 11 bits are a local key signal value and 3 bits are the parity bit. Namely, 1 bit out of the parity bits is a parity bit ‘1’ generated by the switch SW12. The other remaining 2 bits are ‘00’, which does not require a switch by circuit. Namely, the other remaining 2 bits ‘00’ means that the switch is constantly in an OFF state. Accordingly, the CPU 100 determines whether there is an error in the local key signal on the basis of the 3 bits (parity bits) among the inputted 14 bits.

If there is no error in the local key signal 201 on the basis of the parity bit, the CPU 100 outputs display data corresponding to the local key signal to the VFD controller. If, however, there is an error in the local key signal on the basis of the parity bit, the CPU 100 outputs display data corresponding to a previous local key signal to the VFD controller 201.

Then, the VFD controller 201 displays the display data corresponding to the local key signal outputted from the CPU 100 or the display data corresponding to the previous local key signal on the VFD 202.

Meanwhile, the parity bit can be inserted at a position of a most significant bit (MSB) or a least significant bit (LSB) of the local key signal.

The process of inserting the parity bit into the LSB of the local key signal will now be described.

First, the VFD controller 201 receives the 14-bit local key signal from the key input unit 203 and the parity bit generator 205, and outputs the 14-bit local key signal to the CPU 100.

Then, the CPU 100 determines whether there is an error in the local key signal on the basis of the lower 3 bits among the 14-bit local key signal outputted from the VFD controller 201. For example, if the parity bit value is 0×4(100b), the CPU 100 recognizes that a key read command has been normally performed (that is, the CPU recognizes that the local key signal has been normally received), or otherwise, the CPU recognizes that the key read command has been erroneously performed or there is an error in the local key signal due to influence of a noise.

Herein, if the key read command is erroneously recognized, bits read as the parity bit value is 0×7(111b), and if a problem occurs at the control lines (STB, CLK, DIN, and DOUT) due to influence of the noise even if the key read command is normally recognized, other various values than 0×4 can be generated.

Accordingly, if the parity bit value is not 0×4, the CPU 100 determines that there is an error in the inputted local signal. For example, if a read local key value is ‘00011100111010’, the parity bit value is not ‘100’but ‘010’, so the CPU 100 determines the read local key value (‘00011100111010’) as an error.

If the parity bit value is not ‘100’, the VFD controller 201 disregards a currently read local key data, receives display data corresponding to a previously read local key value and displays it on the VFD 502, thereby correcting an error. That is, the VFD controller 201 displays the previous, accurate local key signal again on the VFD 502.

Meanwhile, in determining whether there is an error in the local key signal, only one switch value for the parity bit can be used, and in this respect, in order to accurately determine existence or non-existence of an error in the local key signal, a plurality of parity bits can be read.

As so far described, the VFD driver of the present invention has the following advantages.

That is, for example, since a parity bit is generated and then transmitted together with bits of a local key signal outputted from the local key input unit, a malfunction of the VFD due to a noise can be prevented for user's satisfaction and convenience.

In addition, by using a switch as a unit for preventing a malfunction of the VFD due to a noise, a fabrication cost of the VFD driver can be reduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A VFD(vacuum fluorescent display) driver comprising:
a means for generating a parity bit.

2. The driver of claim 1, wherein the means is a switch installed in a local key input unit of the VFD driver.

3. The driver of claim 1, wherein the VFD driver is installed in a set-top box of a digital TV.

4. The driver of claim 1, wherein the parity bit is used to determine whether there is an error in a local key signal outputted from the local key input unit.

5. A VFD driver installed in a digital TV and having a VFD controller, a VFD, a local key input unit and an IR (Infrared Receiver); comprising:
a means installed in the local key input unit and generating a parity bit to check a parity.

6. The driver of claim 5, wherein the means is a switch.

7. The driver of claim 6, wherein the switch is constantly in an ON state to check the parity.

8. The driver of claim 7, wherein, if there is an error in the local key input signal, the VFD controller disregards the local key signal and displays display data corresponding to a previous local key signal on the VFD.

9. A VFD(vacuum fluorescent display) driver comprising:
a local key input unit for generating a local key signal according to a user's demand;
a parity bit generator for generating a parity bit to determine whether there is an error in the local key signal outputted from the local key input unit;
a VFD controller for transmitting the local key signal and the parity bit to a CPU (Central Processing Unit) installed in a set-top box of a digital TV, and receiving display data corresponding to the local key signal from the CPU; and
a VFD for displaying the display data.

10. The driver of claim 9, wherein the parity bit generator is a plurality of switches.

11. The driver of claim 10, wherein the CPU determines existence or non-existence of an error in the local key input signal on the basis of parity bit values read from the switches.

12. The driver of claim 11, wherein, if there is an error in the local key input signal, the VFD controller disregards the local key signal and displays display data corresponding to a previous local key signal on the VFD.
